(19) United States
(12) Patent Application Publication
(10) Pub. No.: US 2004/0086833 A1
(43) Pub. Date: May 6, 2004

(54) System and method for authoring cognitive learning course

(76) Inventor: Daniel Goldberg, Devon, PA (US)

Correspondence Address: Edward J. Kondracki, Miles & Stockbridge P.C., Suite 500, 1751 Pinnacle Dr., McLean, VA, 22102, US

(21) Appl. No.: 10/337,859

(22) Filed: Jan. 8, 2003

Related U.S. Application Data
(60) Provisional application No. 60/422,502, filed on Oct. 31, 2002.

(51) Int. Cl. G09B 19/00

(52) U.S. Cl. 434/118

(57) ABSTRACT

A system and method for creating a cognitive learning course over a network is disclosed. The method comprises the steps of presenting to a user connected to a network a plurality of options for assembling course content, the plurality of options related to an existing course and a new course, receiving, at a managing location remote from the user, a user's selection of one of the plurality of options, and, accepting, from the user, input for adding, modifying, or deleting course content for assembly, the presenting, receiving, and accepting steps being executed over the network. The options may include editing an existing course and creating a new course.

### FIELD OF THE INVENTION

The present invention generally relates to a system and method for authoring a computer-based cognitive learning course over a network supporting Internet protocols.

### BACKGROUND OF THE INVENTION

In the digital age, society's dependency on computers has become increasingly omnipresent. As their complexity and power progress, computers have been put to new business and recreational uses. Increases in bandwidth coupled with decreasing costs have presented the opportunity to offer distributed software applications with rich content over a network.

These advances have shown that computers and computer networks can produce substantial benefits when applied to certain tasks. Computers and networks aid in completing tasks more efficiently without sacrificing the quality of the results. And in many cases, results may be improved. One such example is in the area of cognitive training. Interactive, computer-based cognitive learning courses are often substantially less expensive then their human-taught counterpart, while maintaining the quality associated with the latter.

Computer-based courses are used to teach a variety of topics ranging from elementary education subject matter to cutting-edge technology subject matter. While there are numerous systems and methods for the delivery of such cognitive learning courses, there are few systems and methods for managing their content. Known systems generally require a user to load proprietary software onto a personal computer and server.

Frequently, management content tools are designed for technical individuals, such as computer programmers. These content management tools require the course author to have experience in one or more computer programming languages, such as Perl, HTML, Java, PHP, etc., thereby severely limiting the number of individuals who can create or edit course structure or instructive content. Using these tools, the course is authored in a software development environment, which is often complex and not suitable for authoring a cognitive learning course. This complexity may add significant development time to the cognitive learning course.

U.S. Pat. No. 6,162,060, Richard et al., discloses a system and method for delivery, authoring, and management of courseware over a computer network wherein a proprietary course authoring software module residing on a workstation is operable to transfer a course from the workstation to a course repository remote from the workstation once the course has been authored. This distributed architecture presents several disadvantages. The proprietary authoring system module must be distributed to each user, adding undesirable installation costs. Furthermore, it becomes difficult to maintain the authoring system, because it is not at a centralized location, adding undesirable maintenance costs.

### SUMMARY OF THE INVENTION

A system and method for authoring a cognitive learning course and which overcomes the aforementioned disadvantages is disclosed herein. In one embodiment, the system comprises a course authoring engine for dynamically generating a plurality of display screens deliverable over a network, wherein the plurality of display screens are adapted for receiving an addition, modification, or deletion of course content from an author for either creating a new course or modifying an existing course. The course content includes course structure content, which describes the structure of the course, and course instructive content, which is organized within the course structure and forms the subject matter that is taught by the course.

The system of the present invention further comprises a first personal data repository for storing a personal course library, a second master data repository for storing a master course library, and a third data repository for storing templates and graphics used in authoring a course. The personal course library comprises courses that the author may have created during a previous authoring session, whereas the master library comprises a plurality of “generic” courses on a variety of topics. The author may fully modify the content of these master courses by copying one of these courses into the personal library. Generally, these master courses comprise content authored by “experts.” The author may add new content, modify existing content, or delete content of a copy of a master course added to the personal course library using the display screens generated by the course authoring engine. Upon submission of the content, the authoring engine stores the content in the personal data repository.

Once authoring is completed, a student has access to the course over a network and at a location which may be remote from the author.

### BRIEF DESCRIPTION OF THE DRAWINGS

The following detailed description, given by way of example and not intended to limit the present invention thereto, will best be appreciated in conjunction with the accompanying drawings, wherein like reference numerals denote like elements and parts, in which:

FIG. 1 shows a computer network environment in which one embodiment of the invention operates;

FIG. 2 shows a system architecture overview in accordance with one embodiment of the invention;

FIG. 3 is an illustration of a web page of the course authoring system in accordance with one embodiment of the invention that allows an author to login;

FIG. 4 is an illustration of a web page of the course authoring system in accordance with one embodiment of the invention that displays to the author a list of courses of the personalized course library;

FIG. 5 is an illustration of a web page of the course authoring system in accordance with one embodiment of the invention that displays to the author a list of courses in the master course library;

FIG. 6 is an illustration of a web page of the course authoring system in accordance with one embodiment of the invention that allows a user to create a new course;

FIG. 7 is an illustration of a window of the course authoring system in accordance with one embodiment of the invention that allows an author to select a graphic for use by a course;

FIG. 8 is an illustration of a web page of the course authoring system in accordance with one embodiment of the invention for displaying existing sections of a course and adding new sections thereto;

FIG. 9 is an illustration of a web page of the course authoring system in accordance with one embodiment of the invention for displaying existing subsections of a course and adding new subsections thereto;

FIG. 10 is an illustration of a web page of the course authoring system in accordance with one embodiment of the invention for displaying existing pages of a course and adding new pages thereto;

FIG. 11 is an illustration of a window of the course authoring system in accordance with one embodiment of the invention for selecting a page template;

FIG. 12 is an illustration of a window of the course authoring system in accordance with one embodiment of the invention for selecting a page template;

FIG. 13 is an illustration of a window of the course authoring system in accordance with one embodiment of the invention for selecting a page template;

FIG. 14 is an illustration of a window of the course authoring system in accordance with one embodiment of the invention for displaying existing instructive content and adding new instructive content;

FIG. 15 is an illustration of a window of the course authoring system in accordance with one embodiment of the invention for displaying existing instructive content and adding new instructive content;

FIG. 16 is an illustration of a window of the course authoring system in accordance with one embodiment of the invention for displaying existing instructive content and adding new instructive content;

FIG. 17 shows the data structure of the course authoring system in accordance with one embodiment of the invention; and

FIG. 18 is a flow chart for the operation of the course authoring system in accordance with one embodiment of the invention.

### DETAILED DESCRIPTION OF THE INVENTION

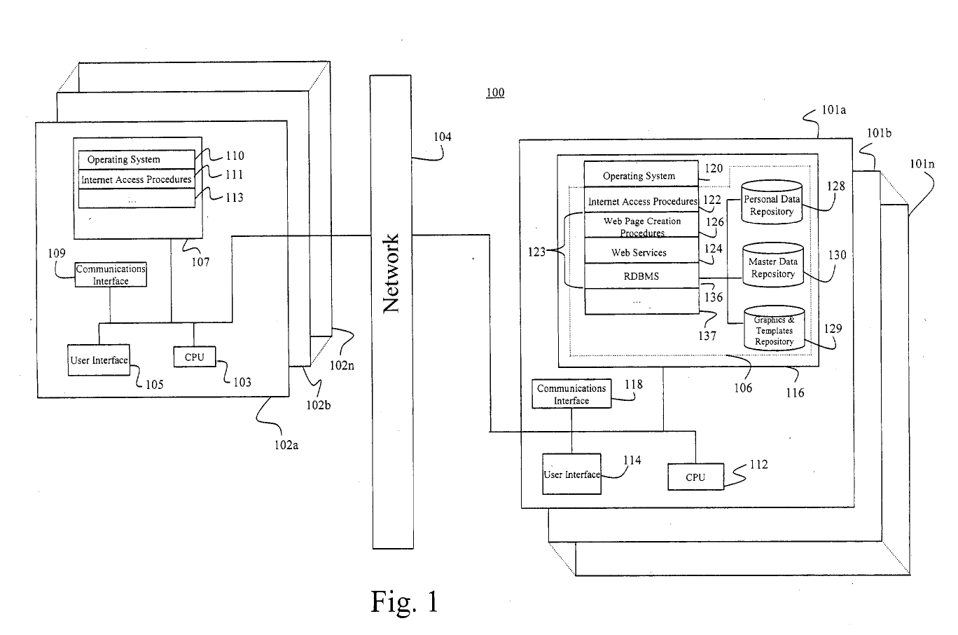

FIG. 1 illustrates a system 100 assimilating an embodiment of the present invention including a number of client computers 102a . . . 102n and one or more server computers 101a . . . 101n each having a course authoring system 106 in communication via a communications link 104. In a preferred embodiment, course authoring system 106 is a server computer.

The communication link 104 generically refers to any type of wire or wireless link between computers, such as a global computer network like the Internet. Although the present invention is designed for the Internet, it may be used on any network supporting Internet protocols such as a wide area network, a local area network, or a combination of networks.

The client computer 102 can be any type of computing device, such as but not limited to, desktop computers, workstations, laptops, and/or mainframe computers. One or more authors (not shown) can be associated with each client computer 102.

Each client computer 102 includes a central processing unit (CPU) 103, a user interface 105, a memory 107, and a communication interface 109. Communications interface 109 is used to communicate with server computer 101 as well as other system resources of the type well known in the art but not shown. Memory 107 of client computer 102 may be implemented as RAM (random access memory) or a combination of RAM and non-volatile memory such as magnetic disk storage. Memory 107 can contain the following:

an operating system 110;

Internet access procedures 111;

as well as other procedures and files 113.

Server computer 101 includes a CPU 112, a user interface 114, a memory 116, and a communications interface 118. Course authoring system 106 can be any type of computing device, such as but not limited to, server computers, desktop computers, workstations, laptops, and/or mainframe computers. Communication interface 118 is used to communicate with client computers 102 as well as other system resources of the type well known in the art but not shown.

Course authoring system 106 includes memory 116 which may be implemented as RAM (random access memory) or a combination of RAM and non-volatile memory such as magnetic disk storage. Memory 116 can contain the following:

an operating system 120;

Internet access procedures 122; and

a course authoring system 106 comprising:

a course authoring engine 123 comprising web server procedures 124 that host web pages that may be accessed by client computers 102, and web page creation procedures 126 that dynamically generate web pages in response to input from the author at client computer 102;

a personal data repository 128 for storing course content of a personal course library;

a templates and graphics data repository 129 for storing a page template library and a graphics library;

a master data repository 130 for storing course content of a master course library;

a relational database management system (RDBMS) 136 for managing queries and data information flow to and from data repository 128; and

other procedures and data structures 137.

It should be appreciated that for explanatory and clarification purposes, data repositories 128, 129, 130 are each referenced as a single element in the present embodiment. It is important to note that any number of data repositories may maintain course content.

Course authoring system 106 generates a graphical user interface (GUI) that is designed to allow for user-friendly control of system 106 from the remote location of client computer 102. In the present embodiment, the GUI is a website comprising a series of web pages that are delivered to an author at client computers 102 over network 104 for viewing through an associated web browser.

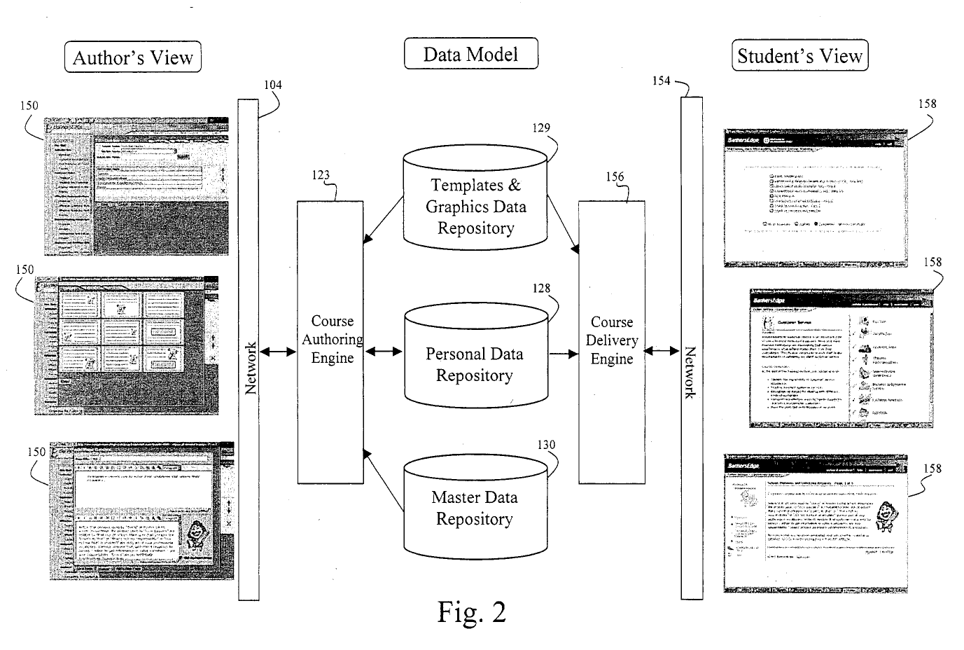

FIG. 2 shows an architecture overview of system 100. The GUI comprises a plurality of authoring screens 150 generated by web page creation procedures 126 of FIG. 1. In the present embodiment, screens 150 are Active Server Pages (.aspx) run under the Microsoft .NET framework. It should be appreciated that the web pages may be created using a variety of programming languages supporting dynamic scripting such as Common Gateway Interface (CGI), Active X, Jscript, VBScript, and other scripting languages. In the present embodiment, the GUI supports extensible markup language (XML) to facilitate seamless data communication with data repositories 128, 129, 130, although XML is not a requirement for implementation or use of the present invention. It should further be appreciated that the present invention is not confined to the NET architecture, and may alternatively employ Enterprise Java Beans (EJB), ColdFusion, or other architectures supporting dynamic web services.

Course authoring engine 123 generates authoring screens 150 which are transmitted to client computer 102 so that an author may edit an existing course or create a new course. If the author elects to edit an exiting course from the personal course library, authoring engine 123 retrieves course content from personal data repository 128 and templates and graphics data repository 129 for the dynamic generation of screens 150. The author may submit additions, modifications, or deletions using screens 150 with respect thereof to authoring engine 123, which would, in turn, update personal data repository 128. If the author elects to use a master course as the foundation for creating a new course, authoring engine 123 copies course content of the selected master course from master data repository 130 to personal data repository 128. Authoring engine 123 then treats the copy of the master course as it would any existing course in the personal course library. If the author elects to create a new course, authoring engine 123 generates screens 150 without any course content displayed therein. Upon submission of new course content, authoring engine 123 stores the content in personal data repository 128.

A course may be published by delivery over network 154 by course delivery engine 156 to a client computer 102. Delivery engine 156 pulls course data from repositories 128, 129 for publishing to a plurality of student screens 158. A student taking the course may view and interact with student screens 158, but student screens 158 do not allow the student to modify the content of data repository 128.

A feature of the present invention is that the complex technicalities normally associated with authoring a cognitive learning course for delivery over a network are substantially reduced. An author is not required to be proficient in computer graphics, screen design, or any computer programming language(s). Instead, an author merely is required to be familiar using web forms such as that of authoring screens 150. In this manner, course authoring system 106 is designed for use by the non-technical user.

Exemplary illustrations of authoring screens 150 will now be described.

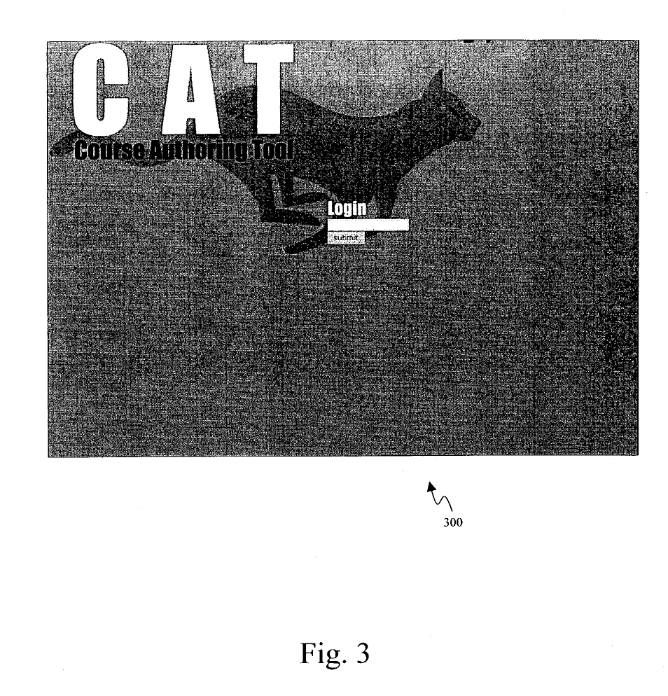

An exemplary illustration of a login screen 300 is shown in FIG. 3. An author logs into system 106 via login screen 300 for accessing the course authoring capabilities of system. Login screen 300 is adapted to receive a username and/or password of the author. The author may gain access or alternatively be denied access because, for example, there is no record of the submitted username and/or password. The author login requirement prevents unauthorized access to system 106. Of course, other graphical representations of login screen 300 are possible, as is the case with any of the screens described herein.

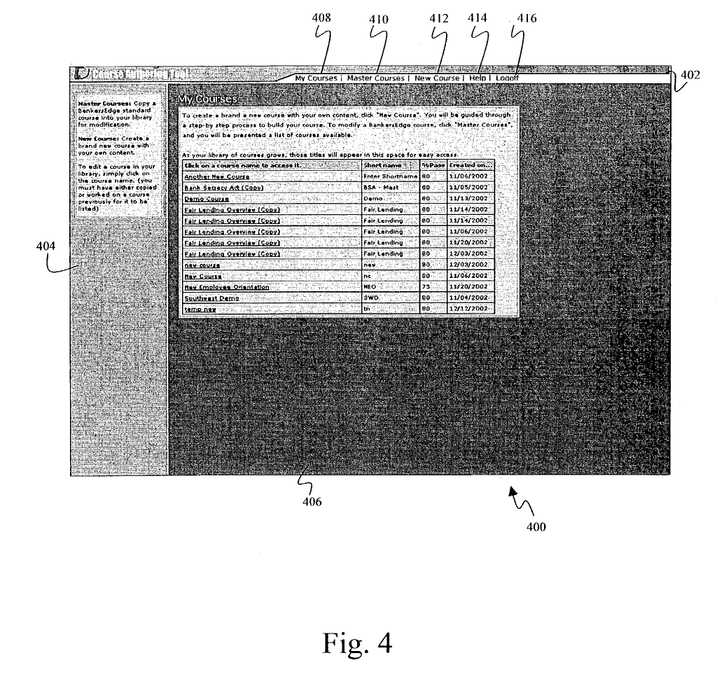

Upon authorization of a username and/or password, authoring engine 123 generates screens 150 which the author uses to create a new course or edit an existing course. As shown in an exemplary illustration of FIG. 4, each screen 150 has three panels: a navigation panel 402, a course tree panel 404, and a working panel 406.

Navigation panel 402 is a static navigation bar used to navigate through course authoring system 106. Navigation panel 402 is an always-visible panel that is available to the author throughout screens 150. In the present embodiment, navigation panel 402 comprises a plurality of navigation buttons. The author may select a “My Courses” navigation button 408 for viewing the personal course library, a “Master Course” navigation button 410 for viewing the master course library, a “New Course” navigation button 412 for creating a new course, a “Help” navigation button 414 for general assistance on using system 106, and a “Logoff” navigation button 416 for securely logging out system 106.

Unlike navigation panel 402, course tree panel 404 and working panel 406 are dynamic for displaying course content of the chosen course. Course content includes course structure content, which describes the structure of the course, and course instructive content, which is organized within the course structure and forms the subject matter that is taught by the course. Course tree panel 404 preferably displays a tree-like hierarchical structure representing the course structure content, identifying sections and sub-sections by name. The author may expand or contract to view or hide subsections of the course structure. Upon an author's selection of a section or subsection in course tree panel 404, the course authoring system provides a display in working panel 406 adapted to receive an author's selection to create, modify, or delete the course content of the chosen course. As sections or subsections within a course are added, modified, or deleted, course tree panel 404 is dynamically updated to display the new course structure.

Upon either a successful login or the selection of My Courses navigation button 408, working panel 406 displays the personal course library associated with the username and/or password submitted at login screen 300. FIG. 4 shows an exemplary illustration of working panel 406 showing a personal course library with several existing courses. Working panel 406 displays information such as each course name, course short name, and the percentage of pre- and post-test questions that a student is required to answer correctly to receive credit for taking the course. The author may modify any course in the personal course library.

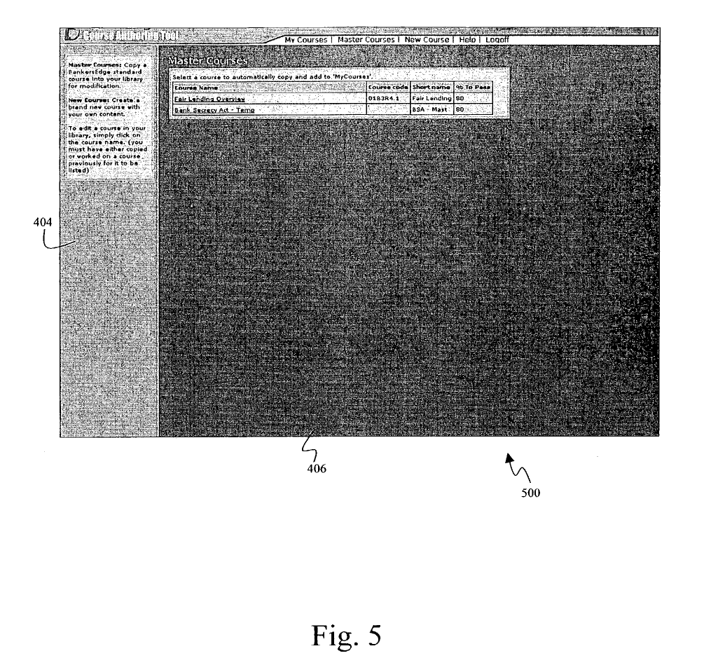

By selecting master course navigation button 410, a master course may be copied from the master course library to the personal course library. Once copied to the personal course library, the author may add, modify, or delete the course's structure or instructive content, just as with any existing course in the personal course library. FIG. 5 shows an exemplary illustration 500 of working panel 406 displaying the master course library comprising a list of master courses available for copying to the personal course library. It is important to note that the author does not have access to altering the structure or instructive content of the original master courses. A master course will comprise the same course structure and instructive content regardless of changes to the copies of master courses placed in the personal course library.

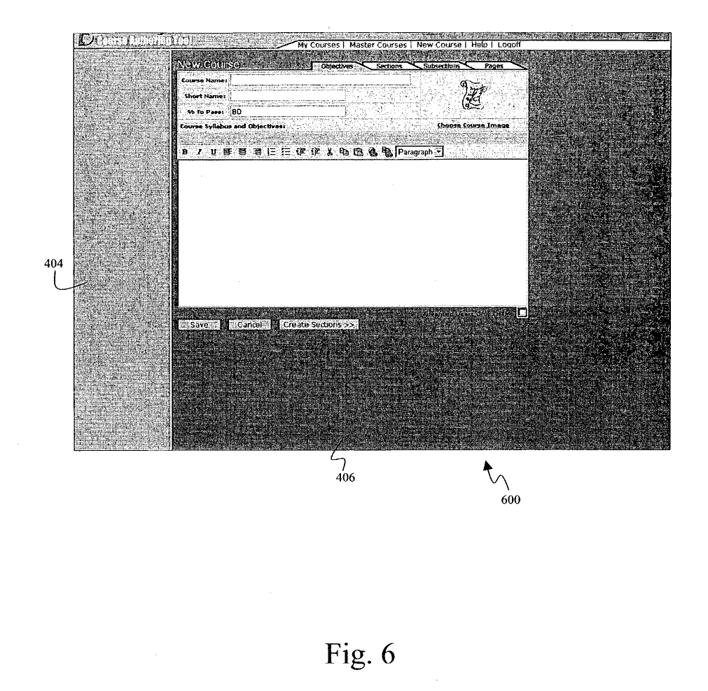

FIG. 6 shows an exemplary illustration 600 of working panel 406 after selecting new course navigation button 412. Working panel 406 provides a display for receiving input directed to the creation of a new course. In the present embodiment, working panel 406 receives a course name, a course short name, and a student-passing requirement. The course name and short name provide identifying indicia for the course. These indicia will be displayed by screen 400 when listing the courses of the personal library. Also, the author may also begin composing instructive content for the new course by using a word processor component. It is preferable that the word processor component offers a simple and intuitive interface that includes basic word processing functionality such as a “cut & paste” operation, text formatting, paragraph formatting, etc. In the present embodiment, working panel 406 instructs the author to input the course syllabus or course objectives into the word processor component. However, it should be appreciated that the content authoring system may accept any instructive course content in the word processing component.

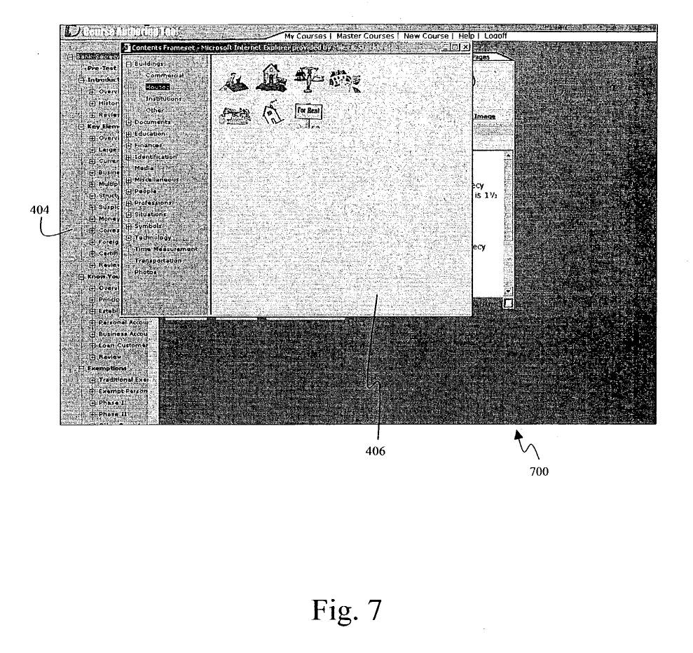

For the purpose of achieving a professional and polished appearance to a course, one or more graphics may be added. In the present embodiment, a graphic may be associated with the course itself and each section or page in the course. FIG. 7 shows an exemplary illustration of a screen 700 after the author has chosen to add a graphic to the course. A graphics library is displayed which permits the author to view and select the image which is to be associated with the course or section. As shown in FIG. 7, the graphics library may be navigated using a theme-based hierarchal tree structure.

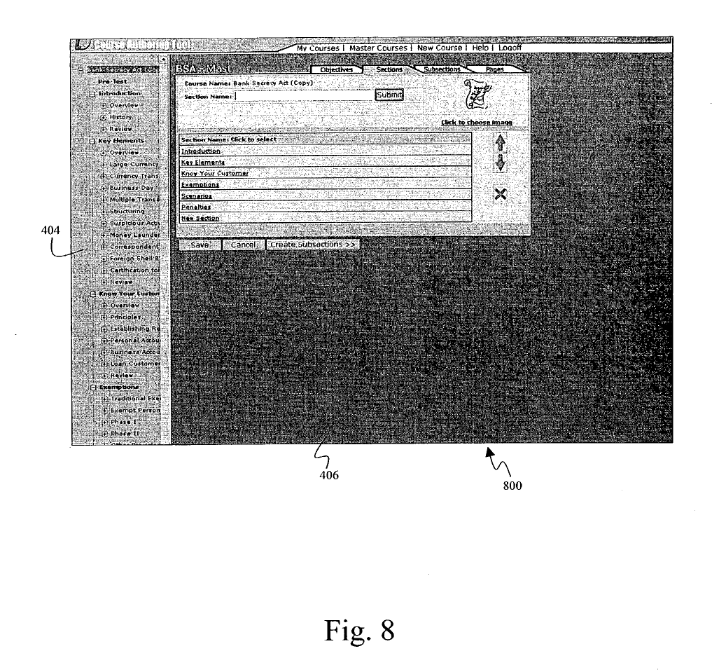

FIG. 8 shows an exemplary illustration of working panel 406 providing a display for the author to make additions, modifications, or deletions to sections of the course structure. Course tree panel 404 now displays structure content comprising sections and subsections, and in the present embodiment, authoring engine 123 generates pre- and post-test sections without any action on the part of the author. There is no limit to the number of sections that an author may submit to the system. As each section is created, a graphic may be associated therewith. No instructive content for the course may be assembled for a section until that section has been created.

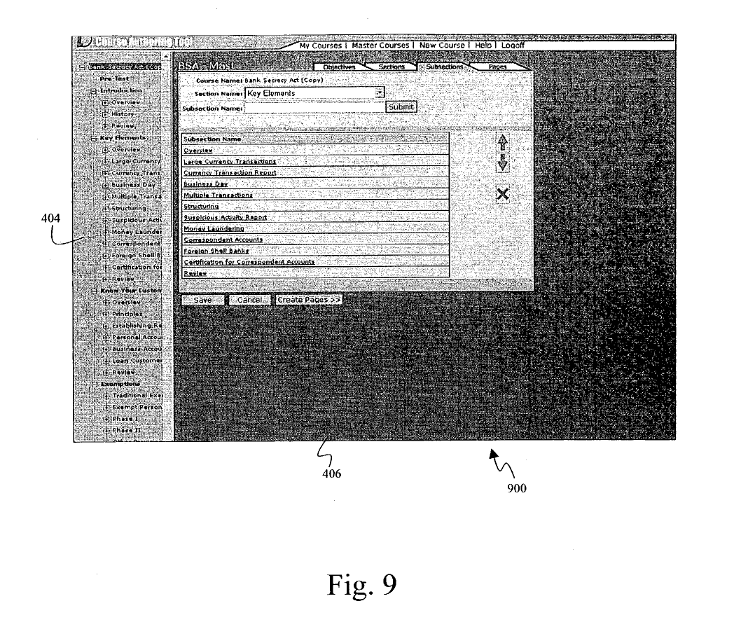

FIG. 9 shows an exemplary illustration of working panel 406 after sections have been submitted for the course structure. Using the display of working panel 406, the author may add, modify, or delete a subsection for any of the existing sections. Each and every subsection must be associated with a section. In the present embodiment, no graphics are associated with the subsections. It should be appreciated that in alternative embodiments, a graphic may be associated with a subsection.

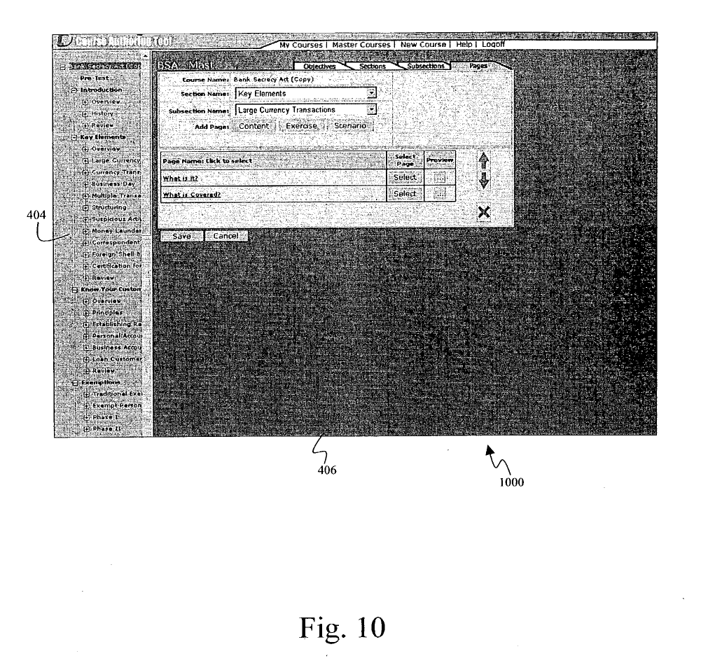

FIG. 10 shows an exemplary illustration of the display of working panel 406 after a plurality of subsections has been submitted. Working panel 406 provides a display for receiving instructive content for organization into the course structure. Each and every page accepted by system 106 is associated with a subsection.

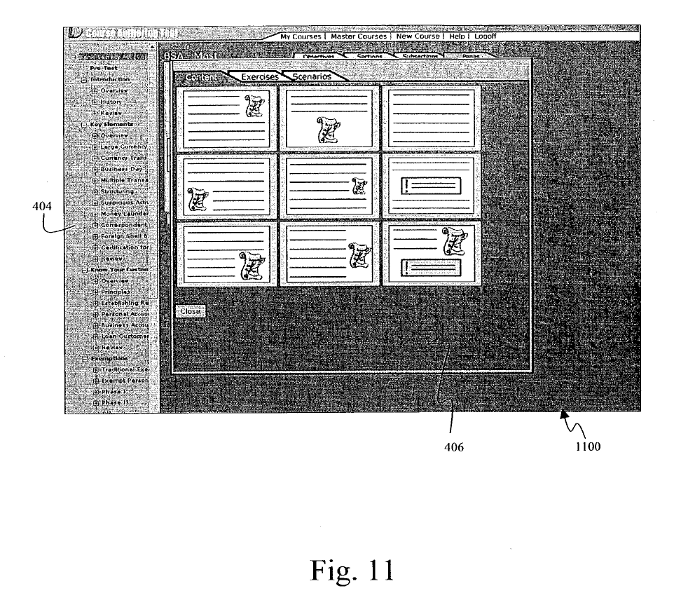

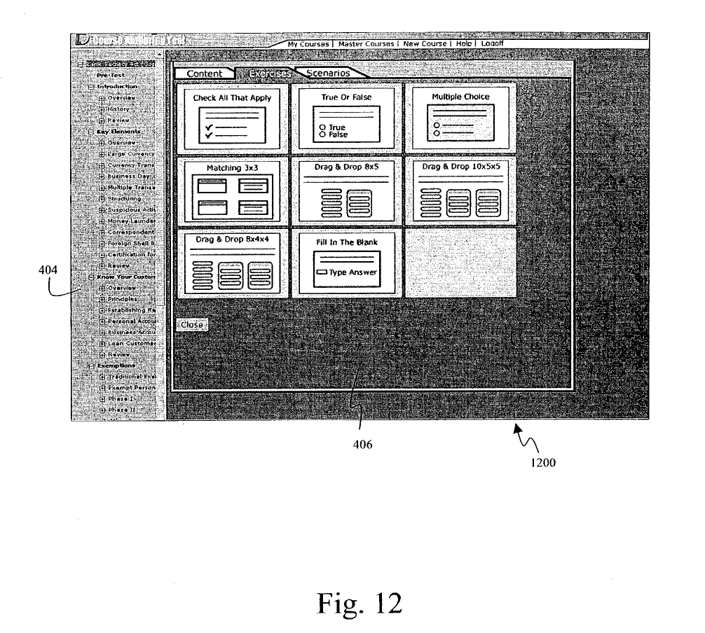

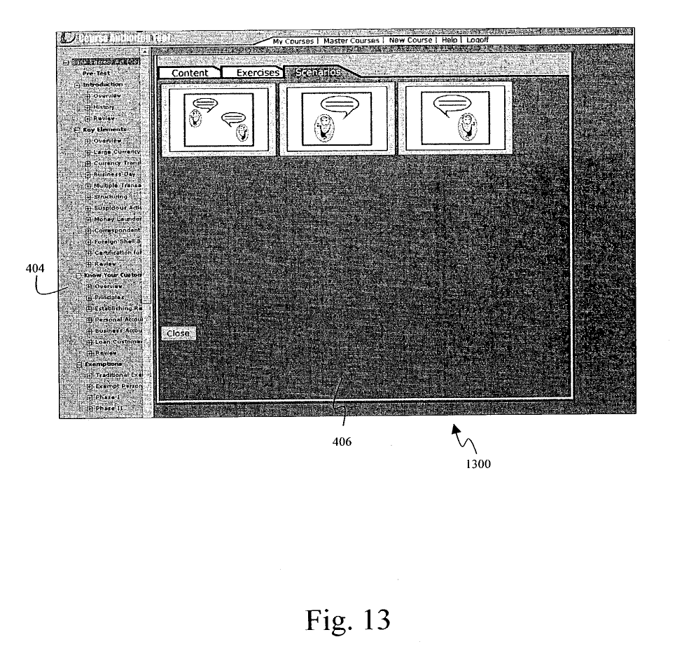

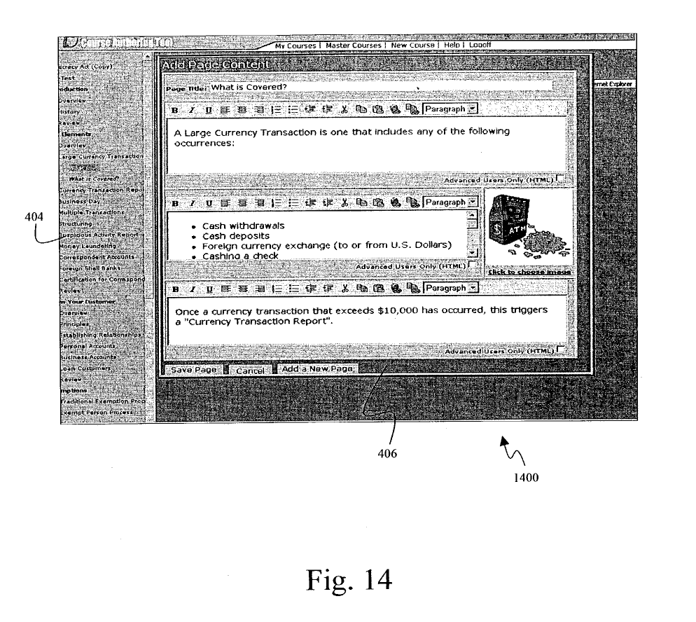

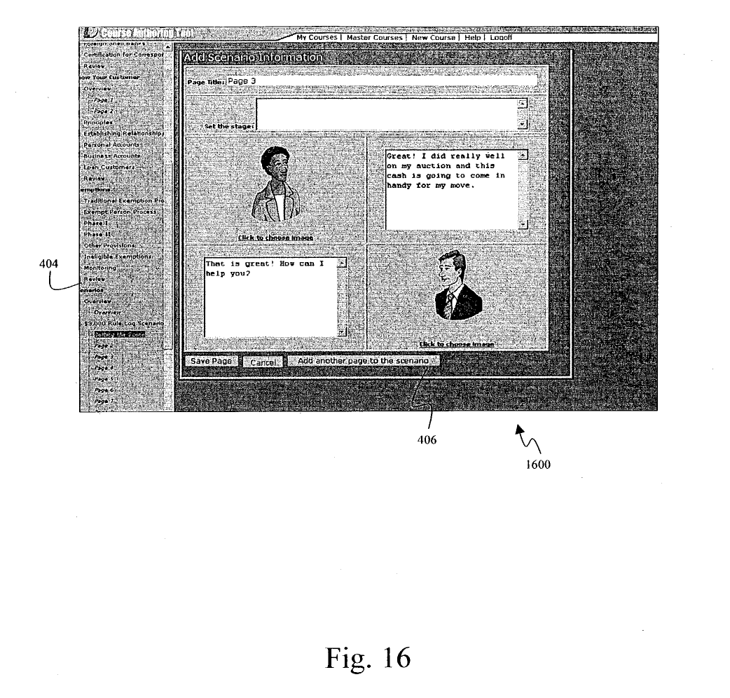

System 106 provides a variety of templates for the presentation of instructive content. In the present embodiment, system 106 makes available a number of templates for presenting general instruction, a number of templates for presenting a review exercise, and a number of templates for presenting a scenario as shown in the exemplary illustrations 1100, 1200, 1300 of FIGS. 11, 12, and 13, respectively. Upon the selection of a template, the course authoring system presents a display for receiving instructive content corresponding to the selected template. FIGS. 14, 15, and 16 each show an exemplary illustration of a display 1400, 1500, 1600 used for submitting the instructive content, the review exercise, and the scenario situation, respectively.

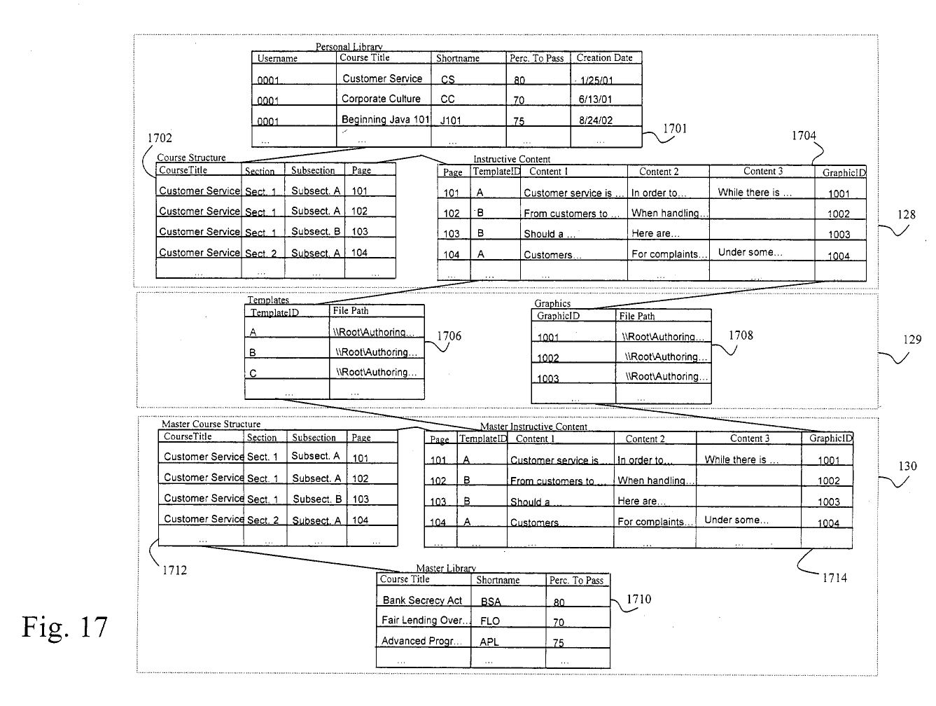

The data structure of course authoring system 106 will now be described with reference to the example data structure of FIG. 17. Data repositories 128, 129, 130 are implemented and managed using RDBMS 136. Data repositories 128, 129, 130 may be implemented using other relational database technology, or other database technology than that described herein, such as those based on the entity-relationship model, the hierarchical model, or the network model. It is preferable that RDBMS 136 supports XML data storage.

Data repository 128 comprises table 1701 for storing a list of courses in the personal course library, a table 1702 for storing course structure content of the author's personal library, and table 1704 for storing course instructive content for organization within the course structure. Table 1701 stores a username for identifying personal course libraries among authors, a course title, a course shortname, a percentage to pass pre- and post-test review questions for course credit, and a creation date. Each course title corresponds to a course title of table 1702.

Each tuple of table 1702 includes a course title, a section title of the aforesaid course title, a subsection title of the aforesaid course title, and a page number of the aforesaid subsection title. Each page number of table 1702 has a corresponding page number of table 1704, as the latter stores the instructive content of each page. Each page number is associated with a templatelD, which is referenced to a corresponding templatelD of table 1706 in data repository 129. The templatelD has a corresponding file path pointing to a web page adapted for receiving instructive content for the corresponding template. Authoring engine 123 may access the web page when an author selects to add, modify, or delete instructive content from an existing course page or create an entirely new course page.

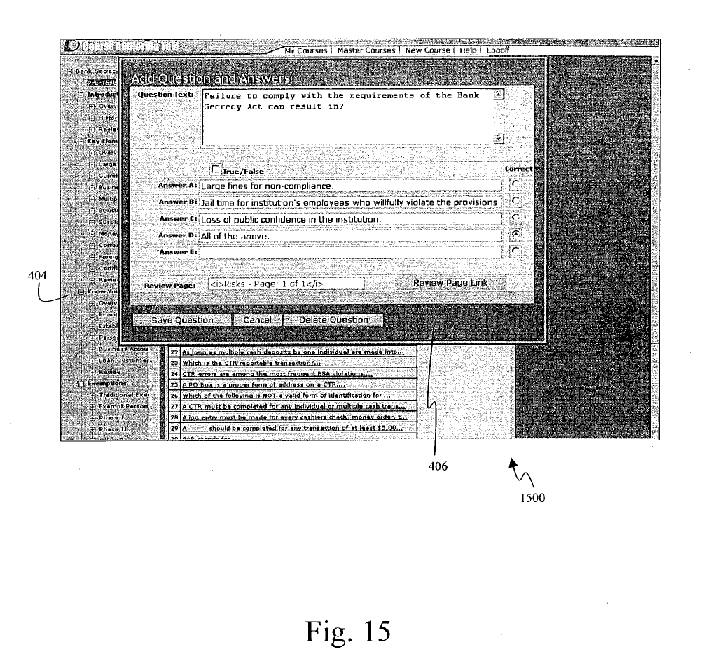

Referring back to table 1704, the text of instructive content pages is stored in the content columns. In the present embedment, template A defines three text areas to which an author may contribute text, such as the template of FIG. 14. Therefore, three of the content columns for the pages using this template contain text. Template B may define two text areas, such as that illustrated in FIG. 15. Therefore, two of the content columns for the pages using this template contain text.

Each tuple of table 1704 may also contain a graphicID. The graphicID is referenced to a corresponding graphicID of table 1708 of data repository 129. The graphiclD of table 1708 corresponds to a file path where the graphic is stored on system 106.

When an author creates a new course to or edits an existing course from the personal course library, changes are made by engine 123 to tables 1701, 1702 and 1704 of data repository 128 only. Engine 123 has read-only permissions to tables 1706 and 1708 of data repository 129.

When an author chooses to edit a master course of the master course library, the selected master course content is copied from tables 1710, 1712, and 1714 of repository 130 and added to tables 1701, 1702, and 1704 of repository 128, respectively. When it is copied, the author's username is affixed to the course content of the copied master course in accordance with the other courses of the personal course library, as well as a creation date. It should be appreciated that the master courses of repository 129 is not associated with a username because access to copying these course is not limited to a particular author. As with repository 129, engine 123 has read-only permissions to repository 130.

When a student takes a course, course delivery engine 156 queries course content from repositories 128, 129 for dynamically constructing student screens 158. Screens 158 may be cached for subsequent access.

It should be appreciated that the data structure of FIG. 17 is by way of example and for explanatory purposes only. In other embodiments, the tables of the data repositories may vary.

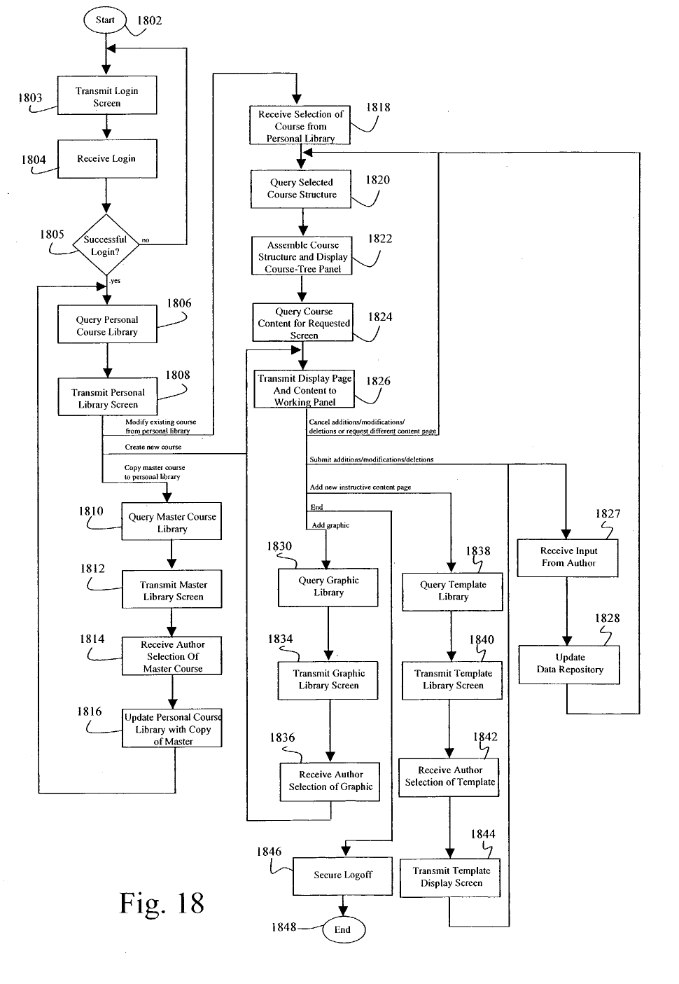

The operation of system 106 will be described with reference to FIG. 18. The process begins at block 1802 and proceeds to block 1803 where the author is presented login screen 300 for accessing authoring system 106. Authoring engine 123 receives a username and/or password at block 1804. At decision block 1805, the username and/or password is compared to login data of data repository 128 to determine if the author has access privileges to the course authoring system. If there is a username and/or password match in data repository 128, then the author is granted access to system 106 beginning at control block 1806. Alternatively, it there is no match, the author is denied access and a new login screen 300 is presented at block 1803.

Upon successful login, authoring engine 123 queries data repository 128 at block 1806 for the personal course library that corresponds to the username and/or login submitted. At block 1808, authoring engine 123 returns display screen 400 to client computer 102 with the results of the query performed at block 1806, including the course name, shortname, percent to pass, and creation dates from data table 1701. If the author is new to the course authoring system, the personal course library will be empty and the query of block 1806 will not return any courses from data table 1701.

Once the personal library is displayed, course authoring engine 123 can receive a variety of inputs from the author at block 1808. Engine 123 may receive either an input for adding a copy of a master course to the personal course library, an input for modifying an existing course in the personal course library, or an input for creating a new course.

If authoring engine 123 receives an input for copying a master course into the personal choice library, authoring engine 123 queries data table 1710 at block 1810 for the master course library and returns a list of master courses at block 1812, commensurate with display screen 500.

At control block 1814, course engine 123 receives the author's selection of a master course. Authoring engine 123 then updates the personal course library at block 1816 by copying the master course content data, including course structure data and instructive content data, from data tables 1710, 1712, 1714 to data tables 1701, 1702, 1704, respectively. As before, the personal library is queried at block 1806 and displayed to the user at block 1808, now with the copy of the master course.

If the author elects to modify an existing course from the personal course library, authoring engine 123 receives the chosen course at control block 1818. Engine 123 then queries data table 1702 at block 1820 for course structure data. Once the structure data is retrieved, the course-tree hierarchy of panel 404 can be compiled at block 1822. At block 1824, data tables 1702, 1704 is queried for the course content to be displayed in working panel 4006, commensurate with display screens 600, 800, 900, 1000. The content retrieved by the query need only be for the requested display. For example, there is no need to request pre- and post-test question content if the author has requested to view a course page of a different section or subsection. Authoring engine 123 transmits the requested instructive content to client computer 102 at block 1826.

The author may then add, modify, or delete course content, including the course structure or instructive content, at client computer 102. However, no updates will be stored in data repository 128 until they are submitted to authoring engine 123. At block 1826, the authoring engine 123 receives one of several selections from the author. If engine 123 is instructed to cancel any modifications made at client computer 102, or if engine 123 is instructed to display different course content, then control flow loops back to block 1820.

At block 1826, authoring engine 123 may receive other selections, including a selection for updating data repository 128 with additions, modifications, or deletions to the current course structure or instructive content. Upon receiving this selection at block 1827, engine 123 updates the appropriate tables in data repository 128 at block 1828 and loops back to block 1820 for loading either the same display page or a new display page at client computer 102.

At block 1826, authoring engine 123 may receive still a different selection, including adding a graphic to the instructive content of course or adding a new page of instructive content to the course.

With the selection to add a graphic, authoring engine 123 queries the graphic library of table 1708 at block 1830. The graphics are transmitted for display at client computer 102 at block 1834, commensurate with display screen 700. An author can then submit their selection, which is received at control block 1836. Authoring engine 123 updates the current display screen with the selected graphic at block 1826, but the graphic must still be submitted to data repository 128 at block 1828 for association with the course.

With the selection to add a new page of instructive content to the course, authoring engine 123 queries the page template library of table 1706 at block 1838, which are transmitted to client computer 102 at block 1840, for a display commensurate with screens 1100, 1200, 1300. The author can then select a template which engine 123 receives at block 1842. Engine 123 provides an appropriate display at block 1:844 adapted to match the text requirements of the selected template, commensurate with screens 1400, 1500, 1600. Engine 123 then receives submission of the instructive content at block 1827 and data repository 128 is updated at control block 1828 with the new content. The display screen is then updated to reflect the new content by cycling through blocks 1820 to 1826.

The author may exit system 106 at any time during its operation, but a secure logoff can be performed by engine 123 at block 1846, ending operation at block 1848.

While this invention has been described in conjunction with specific embodiments thereof, it is evident that many alternatives, modifications and variations will be apparent to those skilled in the art. Accordingly, the preferred embodiments of the invention as set forth herein, are intend to be illustrative, not limiting. Various changes may be made without departing from the true spirit and full scope of the invention as set forth herein and defined in the claims.

1. A method for creating a cognitive learning course comprising the steps of:
presenting to a user connected to a network a plurality of options for assembling course content, the plurality of options related to an existing course and a new course;
receiving, at a managing location remote from the user, a user's selection of one of the plurality of options; and
accepting, from the user, input for adding, modifying, or deleting course content for assembly, the presenting, receiving, and accepting steps being executed over the network.

2. The method of claim 1, wherein the options are editing an existing course and creating a new course.

3. The method of claim 2, wherein the course content comprises course structure describing the structure of the course, and instructive content for organization within the course structure.

4. The method of claim 2, wherein the existing course is selected from either a personal course library or a master course library.

5. The method of claim 4, wherein upon the selection of the existing course from the master course library, course content of the master course is copied from the master course library to the personal course library.

6. The method of claim 2, wherein the accepting step comprises the steps of:
providing a plurality of screens to the user for receiving the input for adding, modifying, or deleting course content and submitting the input to the managing location; and
storing the course content sent to the managing location.

7. The method of claim 2, wherein the network is a global computer network.

8. The method of claim 2, wherein the presenting, receiving, and accepting steps are executed between a web browser and the managing location.

9. A system for authoring a cognitive learning course over a network comprising:
a course authoring engine for generating at least one display screen deliverable over the network, the display screen adapted for receiving a selection for creating a new course or modifying an existing course;
at least one data repository for storing course content data including course structure content data and instructive content data; and
a database management system for facilitating the exchange of course content data between the course authoring engine and the data repository.

10. The system of claim 9, wherein the display screens is a web page viewable in a web browser.

11. The system of claim 9, wherein the network is a global computer network.

12. The system of claim 9, wherein if the course authoring engine receives a selection for modifying an existing course, dynamically generating a plurality of display screens with course content from the data repository, the display screens adapted for receiving additions, modifications, or deletions to the course content.

13. The system of claim 11, wherein upon any addition, modification, or deletion to the course content, the course authoring engine updates the data repository.

14. A computer readable medium having stored thereon one or more sequences of instructions for causing one or more microprocessors to perform steps for providing a course authoring system deliverable over a network, the steps comprising:
presenting to a user connected to a network a plurality of options for assembling course content, the plurality of options including editing an existing course and creating a new course;
receiving, at a managing location remote from the user, a user's selection of one of the plurality of options; and
accepting, from the user, input for adding, modifying, or deleting course content for assembly, the presenting, receiving, and accepting steps being executed over the network.

15. The computer readable medium of claim 14, wherein the course content comprises course structure describing the structure of the course, and instructive content for organization within the course structure.

16. The computer readable medium of claim 15, wherein the existing course is selected from either a personal course library or a master course library.

17. The computer readable medium of claim 16, wherein upon the selection of the existing course from the master course library, course content of the master course is copied from the master course library to the personal course library.

18. The computer readable medium of claim 14, wherein the accepting step comprises the steps of:
providing a plurality of screens to the user for receiving the input for adding, modifying, or deleting course content and submitting the input to the managing location; and
storing the course content sent to the managing location.

19. The computer readable medium of claim 14, wherein the network is a global computer network.

20. The computer readable medium of claim 14, wherein the presenting, receiving, and accepting steps are executed between a web browser and the managing location.
